(19) United States
(12) Patent Application Publication
(10) Pub. No.: US 2015/0327343 A1
(43) Pub. Date: Nov. 12, 2015

(54) PLANCKIAN AND NON-PLANCKIAN DIMMING OF SOLID STATE LIGHT SOURCES

(71) Applicant: OSRAM SYLVANIA Inc., Danvers, MA (US)

(72) Inventors: Qi Dai, Danvers, MA (US); Ming Li, Acton, MA (US); Robert Harrison, North Andover, MA (US); Edward Haidar, Somerset, MA (US)

(73) Assignee: OSRAM SYLVANIA INC., Danvers, MA (US)

(21) Appl. No.: 14/394,512

(22) PCT Filed: May 6, 2013
(86) PCT No.: PCT/US2013/039789

§ 371 Date: Oct. 15, 2014

Related U.S. Application Data
(60) Provisional application No. 61/642,881, filed on May 4, 2012.

(51) Int. Cl. H05B 33/08

(52) U.S. Cl. CPC H05B 33/0845; H05B 33/0896

(57) ABSTRACT

Systems and methods of Planckian and non-Planckian dimming of solid state light sources are disclosed. For a given first range of correlated color temperature values on the 1931 CIE Chromaticity Diagram, the current through a plurality of solid state light sources is adjusted so that the light output thereby follows the correlated color temperature values relating to the black body curve over that given first range. For a given second range of correlated color temperature values, the current through a plurality of solid state light sources is adjusted so that the light output thereby deviates from black body curve and instead relates to a series of coordinates that tracks a line between the curve and a color point for one of the solid state light sources.

### CROSS-REFERENCE TO RELATED APPLICATION

The present application claims priority of U.S. Provisional Patent Application No. 61/642,881, filed May 4, 2013 and entitled “PLANCKIAN AND NON-PLANCKIAN DIMMING OF MULTIPLE SOLID STATE LIGHT SOURCES”, the entire contents of which are hereby incorporated by reference.

### TECHNICAL FIELD

The present invention relates to lighting, and more specifically, to dimming solid state light sources.

### BACKGROUND

A conventional light source, such as a halogen lamp or an incandescent lamp, when dimmed, acts like a near exact black body radiator and follows the Planckian curve on the 1931 CIE Chromaticity Diagram. For example, a conventional halogen lamp at its maximum output may output light having a color temperature of 2600K. As that halogen lamp is dimmed, the current running through its tungsten filament is reduced, resulting in a lower, warmer color temperature (e.g., 2000K). Because such dimming results in more red light being included in the output of the lamp, such dimming is typically known as red dimming.

As solid state light sources become more widely used, lighting designers and lighting consumers desire that the solid state light sources behave similarly to conventional light sources. Unlike a halogen lamp, however, as a solid state light source is dimmed, it typically holds its color temperature. This has been overcome to a degree by using a color mixing technique. For example, a solid state light source that generates white light and a solid state light source that generates orange/red light (e.g., 590 nm or substantially 590 nm) may both be placed inside a lighting device. At maximum output, only the white light-generating solid state light source is on. As the output is dimmed, the orange/red light-generating solid state light source is turned on and its intensity is increased, with a corresponding decrease in the white light-generating solid state light source. This mimics the effect of red dimming and the color temperature of the dimmed light output exactly, or nearly exactly, follows the Planckian curve.

### SUMMARY

In an effort to mimic the black body radiator behavior of traditional light sources, conventional techniques for dimming solid state light sources try to generate light having a varying color temperature that exactly (or nearly exactly) follows the Planckian curve of the 1931 CIE Chromaticity Diagram. Such techniques require a variety of additional solid state light sources as well as electrical devices and other components providing constant feedback to, and adjustment of, the solid state light sources. This greatly increases both the cost and the complexity of designing lighting that includes solid state light sources but is able to mimic the dimming of a traditional light source. Further, two color mixing solutions such as described above have a low utilization, due to the second, non-white solid state light source being off when no dimming occurs, and a very strict binning requirement, as the color points of the respective solid state light sources must be closely matched. Such limitations further increase the complexity and cost in designing and producing lighting devices with solid state light sources that dim similarly to conventional light sources.

Embodiments described herein overcome such deficiencies by taking dimming of the solid state light sources off of the Planckian curve. As shown herein, such non-Planckian dimming techniques do a reasonable job of mimicking a black body radiator that dims along the Planckian curve without actually following, or substantially following, the Planckian curve. This is particularly true when trying to mimic the red dimming effect of a conventional halogen light source. Embodiments based on a three or more color solution have high efficacy, high color rendering index (90+), and good source utilization as compared to the prior art. Embodiments also provide accurate color control (within 1˜2 step MacAdam ellipse) within a wide ambient temperature range (for example but not limited to substantially 10° C. to substantially 80° C.), and are more tolerant in regards to color binning, resulting in significant cost savings.

In an embodiment, there is provided a lighting device. The lighting device includes: a plurality of solid state light sources, comprising a first solid state light source having a first color point, a second solid state light source having a second color point, and a third solid state light source having a third color point; a control circuit connected to the plurality of solid state light sources and configured to control an amount of current through each solid state light source in the plurality of solid state light sources to produce a light output for the lighting device; and a memory system connected to the control circuit, wherein the memory system includes, for a range of correlated color temperatures: a first set of data comprising a first plurality of pairs of x-axis coordinates and corresponding y-axis coordinates on the 1931 CIE Chromaticity Diagram, wherein each pair in the first plurality of pairs includes a corresponding luminous flux, wherein each corresponding luminous flux relates to a particular correlated color temperature over a first portion of the range; and a second set of data comprising a second plurality of pairs of x-axis coordinates and corresponding y-axis coordinates on the 1931 CIE Chromaticity Diagram, wherein each pair in the second plurality of pairs includes a corresponding luminous flux, wherein each corresponding luminous flux relates to a particular correlated color temperature over a second portion of the range; wherein the first plurality of pairs for the first portion of the range is determined by taking pairs of x-coordinates and corresponding y-coordinates from a black body curve for a first set of correlated color temperatures within the first portion of the range, and wherein the second plurality of pairs for a second set of correlated color temperatures within the second portion of the range is determined by taking pairs of x-coordinates and corresponding y-coordinates from a line that connects a first end point and a second end point, wherein the first end point is on the black body curve and the second end point is one of the first color point, the second color point, and the third color point.

In a related embodiment, the control circuit may include an input circuit configured to receive an input, and the control circuit may be configured to, in response to the input being received, access the first set of data and the second set of data in the memory system to adjust the light output for the lighting device to a desired setting corresponding to the input. In a further related embodiment, the input may define one of a desired correlated color temperature and a desired luminous flux, for the light output. In another related embodiment, a subset of pairs in the first plurality of pairs in the first set of data may include a dimming level corresponding to the luminous flux of the pair. In a further related embodiment, the control circuit may include an input circuit configured to receive an input, wherein the input includes a desired dimming level, and the control circuit may be configured to, in response to the input being received, access the first set of data and the second set of data in the memory system to adjust the light output for the lighting device to the luminous flux corresponding to the desired dimming level.

In yet another further related embodiment, the line that connects the first end point and the second end point may be a line segment. In still another further related embodiment, the line that connects the first end point and the second end point may be defined by a plurality of line segments, wherein a first line segment in the plurality of line segments may have a first slope, wherein a second line segment in the plurality of line segments may have a second slope, and wherein the first slope may be different from the second slope.

In yet still another further related embodiment, the line that connects the first end point and the second end point may be a curve. In still yet another related embodiment, the line that connects the first end point and the second end point may be a plurality of curves.

In another embodiment, there is provided a method of dimming a plurality of solid state light sources. The method includes: creating a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures; associating a luminous flux and corresponding dim level with each pair in the first plurality of pairs; creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures; associating a luminous flux and corresponding dim level with each pair in the second plurality of pairs; receiving an input, wherein the input identifies a desired dim level; locating, within the first set of data and the second set of data, the pair of x-axis coordinates and corresponding y-axis coordinates, corresponding correlated color temperature, and associated luminous flux for the corresponding dim level that is the same as the desired dim level; and adjusting current to the plurality of solid state light sources to produce light output having a luminous flux that is substantially the luminous flux in the first set of data and the second set of data that is associated with the desired dim level.

In a related embodiment, creating the second set of data may include creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a line segment.

In another related embodiment, creating the second set of data may include creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a curve.

In another embodiment, there is provided a lighting system. The lighting system includes: a plurality of solid state light sources, comprising a first solid state light source having a first color point, a second solid state light source having a second color point, and a third solid state light source having a third color point; a controller connected to the plurality of solid state light sources; and a memory system connected to the controller; wherein the memory system includes a dimming application, a first set of data and a second set of data; wherein the first set of data comprises a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and has an associated luminous flux; wherein the second set of data comprises a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and has an associated luminous flux; and wherein the dimming application, when executed in the controller as a dimming process, performs operations of: receiving an input, wherein the input identifies a desired dim level; locating, within the first set of data and the second set of data, the pair of x-axis coordinates and corresponding y-axis coordinates, corresponding correlated color temperature, and associated luminous flux for the corresponding dim level that is the same as the desired dim level; and adjusting current to the plurality of solid state light sources to produce light output having a luminous flux that is substantially the luminous flux in the first set of data and the second set of data that is associated with the desired dim level.

In another embodiment, there is provided a computer program product, stored on a non-transitory computer readable medium, including instructions that, when executed on a controller in communication with a plurality of solid state light sources, cause the controller to perform operations of: storing a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and includes an associated luminous flux; storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and includes an associated luminous flux; receiving an input, wherein the input identifies a desired luminous flux from the plurality of solid state light sources; locating, within the first set of data and the second set of data, the associated luminous flux that is the same as the desired luminous flux; determining the pair of x-axis coordinates and corresponding y-axis coordinates and corresponding correlated color temperature for the associated luminous flux; and using the determined pair of x-axis coordinates and corresponding y-axis coordinates and corresponding correlated color temperature to adjust current to the plurality of solid state light sources to produce light output having a luminous flux that is substantially the associated luminous flux.

In a related embodiment, the controller may perform operations of storing a first set of data by storing a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and includes an associated luminous flux and corresponding dim level; and the controller may performs operation of storing a second set of data by storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and includes an associated luminous flux and corresponding dim level.

In a further related embodiment, the controller may perform operations of receiving by receiving an input, wherein the input identifies a desired dim level for light output by the plurality of solid state light sources; the controller may perform operations of locating by locating, within the first set of data and the second set of data, the corresponding dim level that is the same as the desired dim level; the controller may perform operations of determining by determining the pair of x-axis coordinates and corresponding y-axis coordinates and corresponding correlated color temperature for the corresponding dim level; and the controller may perform operations of using by using the determined pair of x-axis coordinates and corresponding y-axis coordinates and corresponding correlated color temperature to adjust current to the plurality of solid state light sources to produce light output having a dim level that is substantially the corresponding dim level.

In another related embodiment, the controller may perform operations of storing a second set of data by storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a line segment.

In still another related embodiment, the controller may perform operations of storing a second set of data by storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a curve.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1AA shows a portion of the 1931 CIE chromaticity diagram with an indication of non-Planckian dimming of solid state light sources according to embodiments disclosed herein.

FIG. 1AB shows a graph of a fitted line used to determined information to enable non-Planckian dimming according to embodiments disclosed herein.

FIG. 2 shows a lighting device capable of Planckian and non-Planckian dimming according to embodiments disclosed herein.

FIG. 3 shows a lighting system capable of Planckian and non-Planckian dimming according to embodiments disclosed herein.

FIG. 4 shows a method of dimming a plurality of solid state light sources according to embodiments disclosed herein.

FIG. 5 shows a method of dimming a plurality of solid state light sources according to embodiments disclosed herein.

### DETAILED DESCRIPTION

As used throughout, the term solid state light source(s) refers to one or more light emitting diodes (LEDs), organic light emitting diodes (OLEDs), polymer light emitting diodes (PLEDs), and any other solid state light emitter, and/or combinations thereof. Further, as used throughout, the term correlated color temperature (CCT) refers to a color point on the 1931 CIE chromaticity diagram having particular x and y coordinates (i.e., Cₓ and C_{y}). Some such CCT values are found on the Planckian curve of the 1931 CIE chromaticity diagram and some such CCT values are found off of the Planckian curve, as described below.

Embodiments described herein provide for a lighting device/system including solid state light sources that are controlled so as to be dimmed both along the Planckian curve of the 1931 CIE chromaticity diagram and off of the Planckian curve. Such dimming off the Planckian curve is referred to throughout as “non-Planckian dimming” and includes dimming that is not within the typical tolerance of dimming along the Planckian curve. As is well known with solid state light sources, as the junction temperature of the solid state light sources changes, the color of light emitted thereby fluctuates, particularly when the solid state light sources are being controlled so as to mimic and/or substantially mimic a black body radiator (i.e., follow the Planckian curve and/or substantially follow the Planckian curve). Such fluctuations are not considered to be “non-Planckian dimming” as that term is used throughout.

Embodiments are described herein with the solid state light sources being controlled by combinations of software and hardware. Such combinations may take any variety of known forms, including software instructions stored in a computer system and/or memory device that provide control signals to one or more pulse width modulation device(s) connected to the solid state light sources, instructions stored as firmware within a microcontroller connected to circuitry that modulates the current received by the solid state light sources, and so on. Thus, in some embodiments, the control of dimming of the solid state light sources is within the actual lighting device/system that includes the solid state light sources, while in some embodiments, the control of dimming comes from a source that is external to and connected to a light engine that includes the solid state light sources.

Embodiments are described herein as including a plurality of solid state light sources. For ease of explanation only, references are made throughout to the plurality of solid state light sources including at least one amber, one bluish white, and one mint solid state light source, respectively. Of course, any number of solid state light sources may be used, and any color combination of solid state light sources may be used, so long as there are at least three distinct colors. As used herein, the term amber solid state light source(s) includes a solid state light source that emits light having a wavelength of substantially 605 nm to substantially 650 nm, and in some embodiments has a wavelength of substantially 620 nm. As used herein, the term mint solid state light source(s) includes a solid state light source that generates white light that has a more greenish element to the white light, such that it is above the Planckian curve and is in and/or substantially in the green color space of the 1931 CIE chromaticity diagram. As used herein, the term bluish white solid state light source(s) includes a solid state light source that generates white light and/or substantially white light that has more a bluish element to the white light, such that it is above the Planckian curve and is in and/or substantially in the blue color space of the 1931 CIE chromaticity diagram. The number of solid state light sources used in a particular application will depend on, for example but not limited to, the application for which the light is intended as well as the desired lumen output and desired dimming. For example, a light engine intended for use as a light source in a two foot by two foot luminaire for a commercial application will likely include more solid state light sources than a light engine intended for use in an A19 retrofit lamp.

Embodiments must include at least three solid state light sources, where each of the three solid state light source emits light having a color point that is distinct and/or substantially distinct from the other two. Of course, in some embodiments, the three solid state light sources may be contained in the same chip and/or package. In some embodiments, there are at least four solid state light sources, A, B, C, and D, where A emits light having a color that is distinct from B and C, B emits light having a color that is distinct from A and C, and C emits light having a color that is distinct from A and B, but is similar to D. Further extensions (to at least five solid state light sources, at least six solid state light sources, and so on) are within the scope of embodiments.

Groups of the at least three different color solid state light sources may be arranged in any particular order, though some embodiments include a grouping where an amber solid state light source is in between a mint solid state light source and a bluish white solid state light source. In some embodiments, the arrangement of the solid state light sources in a given group may differ from the arrangement of the solid state light sources in another group and/or groups. Further, in some embodiments, the grouping of solid state light sources may include less than the total number of distinct color solid state light sources. Thus, for example, a first group may have two amber and one mint solid state light sources while a second group has two bluish white and one mint solid state light sources. Alternatively, or additionally, a first group may have two amber solid state light sources, a second group may have one mint and one bluish white solid state light sources, a third group may have one mint and one bluish white solid state light sources, and a fourth group may have one mint, one amber, and one bluish white solid state light sources. The possible combinations are endless.

While embodiments will be described below with respect to red dimming that is non-Planckian, this is for example purposes only, and of course other types of non-Planckian dimming into different parts of the spectrum off the Planckian curve are possible and are contemplated as being within the scope of the invention. Embodiments use control circuitry (for example but not limited to a controller and a memory system with stored instructions thereon along with a current adjustment circuit, e.g., a PWM generator) that, in conjunction with the plurality of solid state light sources (e.g., three distinct colors), generate a particular correlated color temperature (CCT) with good accuracy.

In order to enable non-Planckian dimming, first value for Planckian-dimming (or near Planckian dimming) must be established. For example, a twenty-five watt incandescent or halogen lamp may be connected to a conventional phase cut dimmer, and the output (i.e., luminous flux, measured in lumens) of the lamp as well as the CCT of the lamp may be measured at various dimmer settings (e.g., 100%, 75%, 50%, etc.). An example of a series of such measurements made on a twenty-five watt incandescent lamp connected to a phase cut dimmer may be seen in Table 1 below, with the addition of the X and Y coordinates on the 1931 CIE chromaticity diagram that correspond to the measured CCT:

TABLE 1

| Lumen | Lumen % | CCT | | |
|---|---|---|---|---|
| (lm) | (%) | (K) | CIE X | CIE Y |
| 219.8 | 100.0 | 2595 | 0.4693 | 0.413 |
| 204.5 | 93.0 | 2576 | 0.4707 | 0.4132 |
| 172.9 | 78.7 | 2532 | 0.4745 | 0.4139 |
| 155.1 | 70.6 | 2505 | 0.4768 | 0.4141 |
| 135.4 | 61.6 | 2474 | 0.4797 | 0.4146 |
| 107.8 | 49.0 | 2416 | 0.4849 | 0.4148 |
| 83 | 37.8 | 2356 | 0.4905 | 0.4152 |
| 57.5 | 26.2 | 2281 | 0.4978 | 0.4152 |
| 28.8 | 13.1 | 2143 | 0.5115 | 0.4151 |
| 17.2 | 7.8 | 2058 | 0.5205 | 0.4143 |

It is possible to program the luminous flux of the lighting device as a function of CCT so that when the solid state light sources of the lighting device are dimmed, the light output by the lighting device has a CCT that is similar to that of (for example) an incandescent lamp dimmed to a particular level (e.g., 50%). The flux as a function of CCT of, for example, a 25 W incandescent lamp during dimming is extracted as follows:

Φ(CCT)=(3.012×10⁻⁶CCT²−1.235×10⁻²CCT+12.75)×Φ(2595 K) (Equation 1)

Embodiments including at least three distinct (and/or nearly distinct) color solid state light sources take either three independent inputs, Cₓ, C_{y}, and flux (for both Planckian and non-Planckian dimming), or three independent inputs, Cₓ, C_{y}, and flux for non-Planckian dimming and two independent inputs for Planckian dimming, CCT and flux, and use this information to adjust the output of the solid state light sources to produce the desired CCT, given a particular dimming level.

In other words, using the data in Table 1 above as an example, we know that a conventional 25 W incandescent lamp, when dimmed so that its output is ˜70%, outputs light having a CCT of 2505K. Embodiments are configured so that, when the control circuitry receives a command to dim the output to 70%, the circuitry/software stored thereon refers to, for example but not limited to, a table of stored data (which may, and in some embodiments does, contain data similar to the data of Table 1). The data indicates that a dimming level of ˜70% corresponds to an output lumen level of 155.1 lumens having a CCT of 2505K. The circuitry/software stored thereon then adjust the current provided to the solid state light sources of the lighting device (e.g., by providing data to a PWM generator that is connected to the solid state light sources, which makes the appropriate adjustments to the currents to the solid state light sources) so that the solid state light sources provide light at a lumen level of 155.1 lumens with a CCT of 2505K.

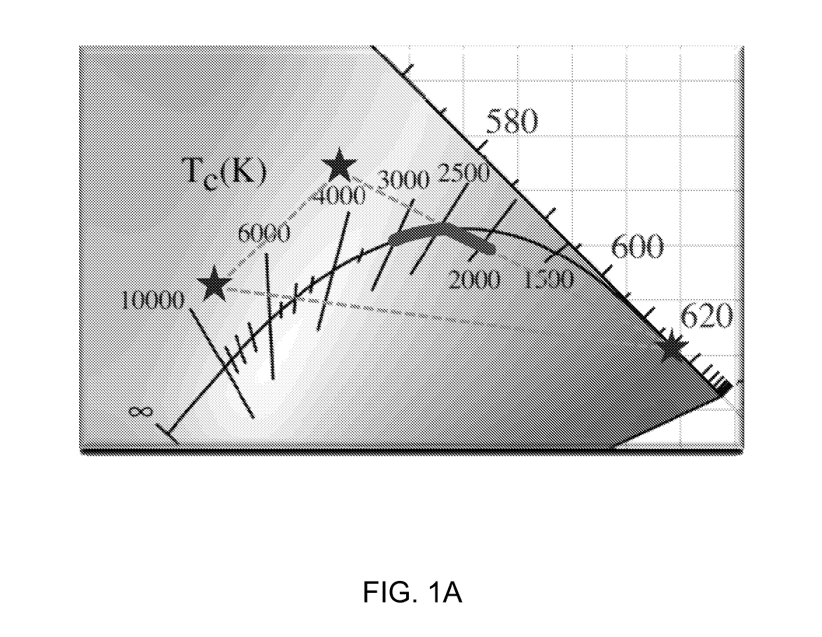

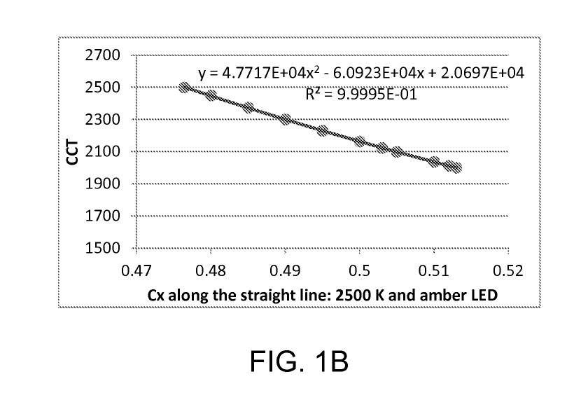

Equation 1 and the corresponding table of data shown in Table 1 are used by embodiments to appropriate tune the solid state light sources for a range of CCT values that is on (or substantially on) the Planckian/black body curve. For example, in embodiments where the lighting device is to mimic red dimming, this range may be from 3000K to 2500K. Of course, the lighting device is likely to be dimmed to levels corresponding to CCT values that are less than 2500K. For such values, however, the lighting device will instead use non-Planckian dimming. In such embodiments, instead of continuing to follow the black body curve past a particular color point, the values used will be off of the black body curve, as is shown in FIG. 1A, where the red line represents the dimming of a lighting device according to embodiments described herein between 3000K and approximately 2000K. From 3000K to 2500K, as shown in FIG. 1A, the red line follows the black body curve (or substantially follows it). From below 2500K to approximately 2000K, the red line veers away from the curve and instead follows a line that intersects the point corresponding to the color point of one of the three color solid state light sources. As shown in FIG. 1A, this color point, at approximately 620 nm, corresponds to the amber solid state light source(s) used in the lighting device, though of course this technique may be used with solid state light sources emitting light of any color point. To obtain the appropriate the Cₓ and C_{y} values for a lumen level corresponding to a CCT of less than 2500K, the point on the curve corresponding to 2500K is connected with the point corresponding to the amber solid state light source(s) by a straight line. In other words, at 2500 K on the curve, Cₓ=0.4764, and C_{y}=0.4137. The point corresponding to the amber solid state light source(s) are (approximately) Cₓ=0.688 and C_{y}=0.307. The luminous flux as a function of Cₓ along the straight line from 2500 K to 2000 K can be calculated as follows, where the range of Cₓ is 0.4764 to 0.5130:

C_{y}=0.6539−0.5043Cₓ (Equation 2)

CCT=4.7717×10⁴(Cₓ)²−6.0923×10⁴Cₓ+2.0697×10⁴ (Equation 3)

Equation 3 shows CCT as a function of Cₓ along the line connecting the 2500 K point on the curve and the point corresponding to the amber solid state light source(s). It is extracted from the fitting shown in the graph of FIG. 1AB. Using Equation 1 from above, the flux percentage at a certain Cₓ is obtained for the second step of the color turning.

Of course, performing non-Planckian dimming does not require using a straight line between a point on the curve and a point somewhere else on the 1931 CIE chromaticity diagram, as is shown above. The connection between a point on the curve and a color point of a solid state light source not on the curve may and in some embodiments does include any set of points therebetween, including but not limited to a curved arc, a squiggly line, a freeform line, a line having a sawtooth style, a line having the style of a square wave, or any other set of points known to be capable of connecting two points in a two-dimensional plane such as the 1931 CIE chromaticity diagram. Thus, in some embodiments, the connection is a line segment, a plurality of line segments, a curve, and/or a plurality of curves, and/or combinations thereof. The connection between the end points will, of course, result in changes to the calculations shown above, in that determining the values for a straight line between two given points in a two-dimensional plane is, for example, different from determining the values for a curved arc between two given points in a two-dimensional plane. Whatever the calculation(s) required, however, the remaining steps are similar in that it is the Cₓ and C_{y} values generated from those calculation(s) that are used by embodiments to accordingly adjust the solid state light sources to produce light output by falling within a desired range of CCT values and/or corresponding to a desired dim and/or lumen level.

The turning point in the range of desired CCT values for embodiments need not be in the center of the range, as is described above, but rather may be at any point that, when connected with a point to create a range of values that does not follow the black body curve, produces a desired dimming effect. As can be seen from looking at FIG. 1A, though the non-Planckian dimming produces color points that are not on the curve, the resultant light output is similar enough to CCT values that are on the Planckian curve to be sufficient to achieve a desired lighting effect without having to exactly (or substantially exactly) follow the curve over the entire range of desired CCT values.

Of course, the initial selection of solid state light sources and their respective output colors help determine the possible non-Planckian dimming options available. The control circuitry/software contained thereon must be programmed according to the available color points of the actual solid state light sources used in order to achieve the non-Planckian dimming.

In some embodiments, dimming may be Planckian, then non-Planckian, then Planckian again for a given range of possible CCT values and appropriate solid state light source selection. Similarly, in some embodiments, dimming may be non-Planckian, then Planckian, then non-Planckian again for a given range of possible CCT values and appropriate solid state light source selection.

Embodiments as described herein ensure that the solid state light sources deliver substantially the same, and in some embodiments the same, percentage of flux as (for example) an incandescent lamp at any CCT within a given CCT range (e.g., 2000K-3000K).

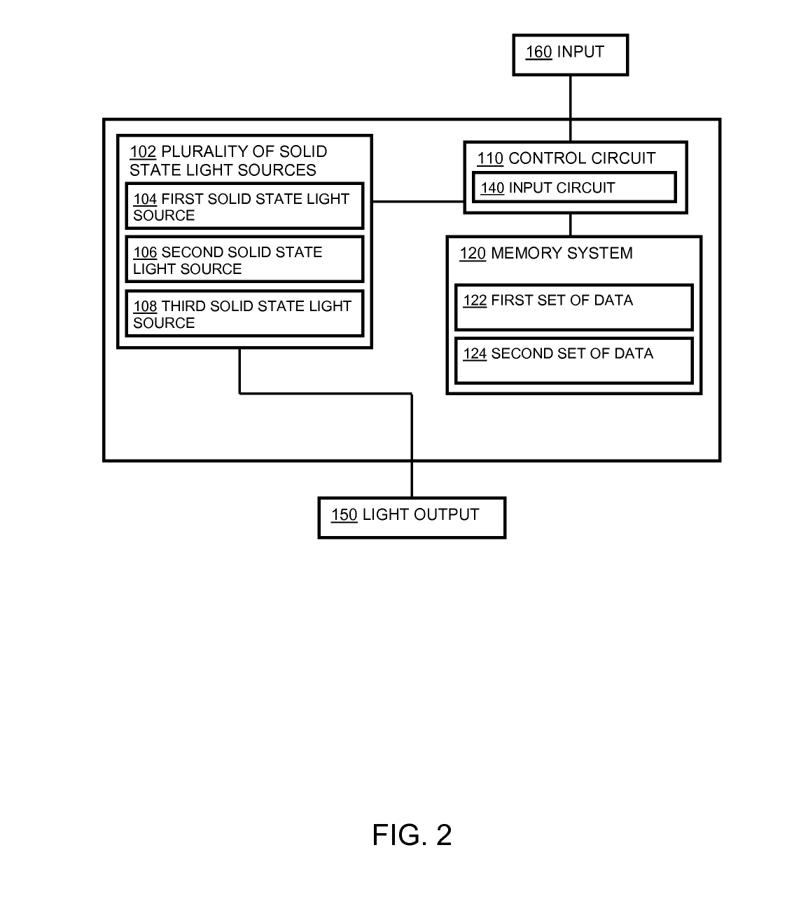

FIG. 2 shows a lighting device 100 capable of Planckian and non-Planckian dimming according to embodiments disclosed herein. The lighting device 100 includes a plurality of solid state light sources 102. The plurality of solid state light sources 102 includes a first solid state light source 104 having a first color point, a second solid state light source 106 having a second color point, and a third solid state light source 108 having a third color point. Of course, in some embodiments, there are multiples of each solid state light source in the plurality of solid state light sources 102, as described above. The lighting device 100 also includes a control circuit 110 connected to the plurality of solid state light sources 102. The control circuit 110 is configured to control an amount of current through each solid state light source 104, 106, 108 in the plurality of solid state light sources 102 to produce a light output 150 for the lighting device 100. A memory system 120 is connected to the control circuit 110. The memory system 120 includes the data that allows for Planckian and non-Planckian dimming of the plurality of solid state light sources 102. Thus, in some embodiments, the memory system 120 includes data similar to that found in Table 1 above and data generated from Equations 1-3 above. More broadly speaking, the memory system 120 includes a first set of data 122, a second set of data 124. The first set of data 122 and the second set of data 124 span a range of correlated color temperatures. The first set of data 122 includes a first plurality of pairs of x-axis coordinates and corresponding y-axis coordinates on the 1931 CIE Chromaticity Diagram, wherein each pair in the first plurality of pairs includes a corresponding luminous flux, wherein each corresponding luminous flux relates to a particular correlated color temperature over a first portion of the range. The second set of data 124 includes a second plurality of pairs of x-axis coordinates and corresponding y-axis coordinates on the 1931 CIE Chromaticity Diagram, wherein each pair in the second plurality of pairs includes a corresponding luminous flux, wherein each corresponding luminous flux relates to a particular correlated color temperature over a second portion of the range. As described above, the first plurality of pairs for the first portion of the range is determined by taking pairs of x-coordinates and corresponding y-coordinates from a black body curve for a first set of correlated color temperatures within the first portion of the range, and the second plurality of pairs for a second set of correlated color temperatures within the second portion of the range is determined by taking pairs of x-coordinates and corresponding y-coordinates from a line that connects a first end point and a second end point, wherein the first end point is on the black body curve and the second end point is one of the first color point, the second color point, and the third color point.

In some embodiments, the control circuit 110 includes an input circuit 140. The input circuit 140 is configured to receive an input 160. In response to the input 160 being received, the control circuit 110 is configured to access the first set of data 122 and the second set of data 124 in the memory system 120 to adjust the light output 150 for the lighting device 100 to a desired setting corresponding to the input 160. In some embodiments, the input 160 defines one of a desired correlated color temperature and a desired luminous flux, for the light output 150. In some embodiments, a subset of pairs in the first plurality of pairs in the first set of data 122 includes a dimming level corresponding to the luminous flux of the pair. In some embodiments, a subset of pairs in the second plurality of pairs in the second set of data 124 includes a dimming level corresponding to the luminous flux of the pair. In some embodiments, the input circuit 140 receives an input 160 that includes a desired dimming level, and the control circuit 110 is configured to, in response, access the first set of data 122 and the second set of data 124 in the memory system 120 to adjust the light output 150 for the lighting device 100 to the luminous flux corresponding to the desired dimming level.

Though the first set of data 122 and the second set of data 124 are shown in FIG. 2 as being distinct, of course in some embodiments these are grouped together in the same set (such as but not limited to a table of data including both sets). This is true for all figures that show the first set of data and the second set of data as being distinct.

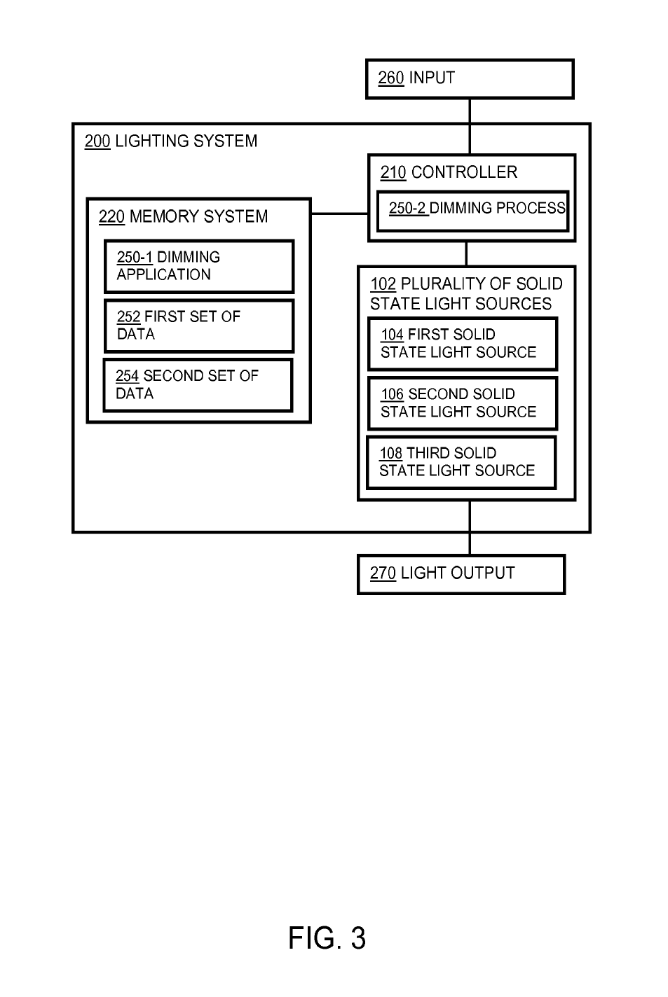

FIG. 3 is a block diagram illustrating example architecture of a lighting system 200 that is capable of dimming a plurality of solid state light sources 102 via a controller 210 and a memory system 220. The lighting system 200 executes, runs, interprets, operates or otherwise performs a dimming application 250-1 and a dimming process 250-2 suitable for use in explaining example configurations disclosed herein.

The lighting system 200 may be realized by using any type of computerized device such as but not limited to a personal computer, workstation, portable computing device, console, laptop, network terminal, tablet, smartphone, or the like. As shown in FIG. 3, the lighting system 200 includes an interconnection such as a data bus or other circuitry that couples the memory system 220 and the controller 210. An optional input 260 may be, and in some embodiments is, coupled to the controller 210 to allow a user to provide input to the lighting system 200. Alternatively, or additionally, the optional input 260 may be realized through use of a touchscreen and/or other touch-sensitive device or any other known input device.

The memory system 220 is any type of computer readable medium and in some embodiments is encoded with a dimming application 250-1 that includes a dimming process 250-2. The dimming application 250-1 may be, and in some embodiments is, embodied as software code such as data and/or logic instructions (e.g., code stored in the memory system 220 or on another computer readable medium such as a removable flashdrive) that supports processing functionality according to different embodiments described herein. During operation of the lighting system 200, the controller 210 accesses the memory system 220 via the interconnection in order to launch, run, execute, interpret or otherwise perform the logic instructions of the dimming application 250-1. Execution of the dimming application 250-1 in this manner produces processing functionality in a dimming process 250-2. In other words, the dimming process 250-2 represents one or more portions or runtime instances of the dimming application 250-1 performing or executing within or upon the controller 210 in the lighting system 200 at runtime.

It is noted that example configurations disclosed herein include the dimming application 250-1 itself including the dimming process 250-2 (i.e., in the form of un-executed or non-performing logic instructions and/or data). The dimming application 250-1 may be stored on a computer readable medium (such as a floppy disk, compact disc, DVD, flash drive, solid state disk, etc.), hard disk, electronic, magnetic, optical or other computer readable medium. The dimming application 250-1 may also be stored in the memory system 220 such as in firmware, read only memory (ROM), or, as in this example, as executable code in, for example, Random Access Memory (RAM). In addition to these embodiments, it should also be noted that other embodiments herein include the execution of the dimming application 250-1 in the controller 210 as the dimming process 250-2. Those skilled in the art will understand that the lighting system 200 may include other processes and/or software and hardware components, such as an operating system and/or network interface not shown herein.

The lighting system 200 is capable of Planckian and non-Planckian dimming according to embodiments disclosed herein. The lighting system 200 is similar to the lighting device 100, in that it also includes a plurality of solid state light sources 102, including a first solid state light source 104 having a first color point, a second solid state light source 106 having a second color point, and a third solid state light source 108 having a third color point. In contrast to the lighting device 100, the lighting system 200 includes the controller 210 connected to the plurality of solid state light sources 102 and the memory system 220 connected to the controller 210. The memory system 220 includes a dimming application 250-1, a first set of data 252, and a second set of data 254. The first set of data 252 comprises a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and has an associated luminous flux. The second set of data 254 comprises a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and has an associated luminous flux. The dimming application 250-1, when executed in the controller 210 as a dimming process 250-2, performs various operations as described herein. First, the dimming process 250-2 receives an input 260. The input 260 identifies a desired dim level for the plurality of solid state light sources 102. The dimming process 150-2 then locates, within the first set of data 252 and the second set of data 254, the pair of x-axis coordinates and corresponding y-axis coordinates, corresponding correlated color temperature, and associated luminous flux for the corresponding dim level that is the same as the desired dim level of the input 260. The dimming process 150-2 then adjusts current to the plurality of solid state light sources 102 to produce light output 270 having a luminous flux that is substantially the luminous flux in the first set of data 252 and the second set of data 254 that is associated with the desired dim level of the input 260.

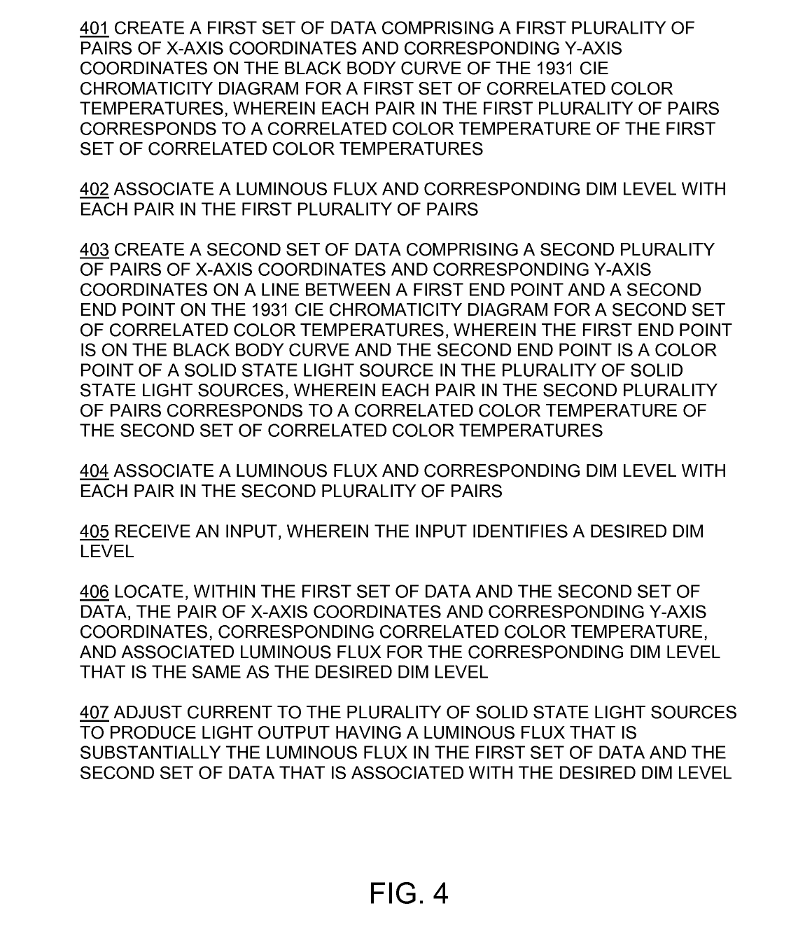

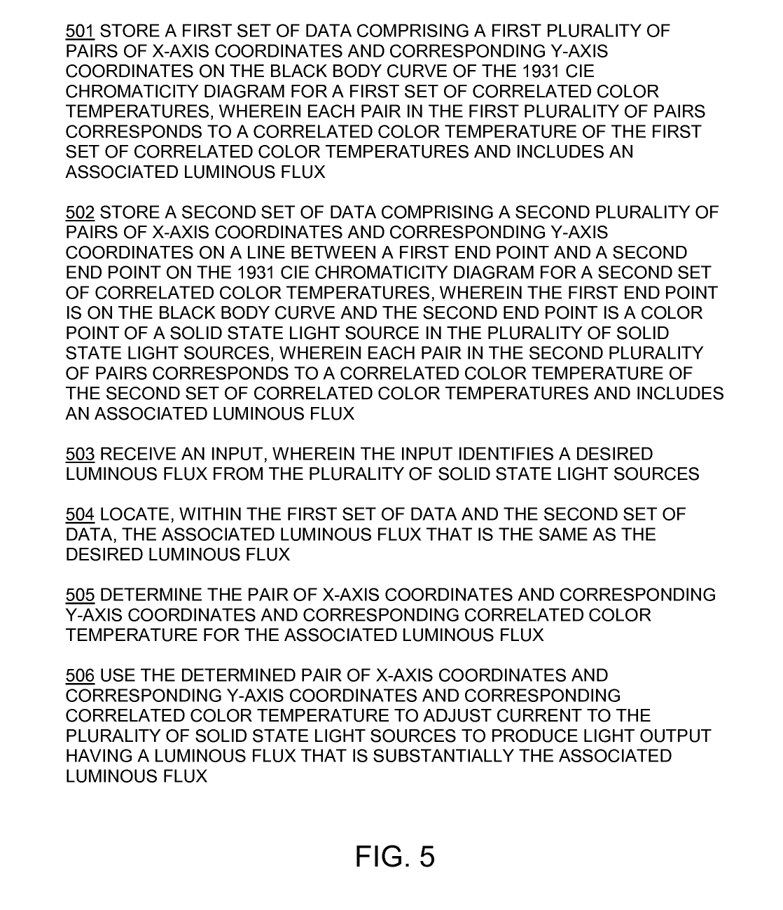

FIG. 4 shows a method of dimming a plurality of solid state light sources according to embodiments disclosed herein. FIG. 5 shows a method of dimming a plurality of solid state light sources according to embodiments disclosed herein. Both FIG. 4 and FIG. 5 show their respective methods in flowchart form. In embodiments including computer software, the rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flowcharts do not depict the syntax of any particular programming language. Rather, the flowcharts illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and may be varied without departing from the spirit of the invention. Thus, unless otherwise stated, the steps described below are unordered, meaning that, when possible, the steps may be performed in any convenient or desirable order.

In FIG. 4, a first set of data is created, step 401. The first set of data includes a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures. A luminous flux and corresponding dim level are then associated with each pair in the first plurality of pairs, step 402. A second set of data is created, step 403. The second set of data includes a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures. A luminous flux and corresponding dim level are associated with each pair in the second plurality of pairs, step 404. An input is received, step 405, wherein the input identifies a desired dim level. Within the first set of data and the second set of data, the pair of x-axis coordinates and corresponding y-axis coordinates, corresponding correlated color temperature, and associated luminous flux for the corresponding dim level that is the same as the desired dim level are located, step 406. Finally, current to the plurality of solid state light sources is adjusted, step 407, to produce light output having a luminous flux that is substantially the luminous flux in the first set of data and the second set of data that is associated with the desired dim level.

In FIG. 5, a first set of data is stored, step 501. The first set of data includes a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and includes an associated luminous flux. A second set of data is then stored, step 502, the second set of data including a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and includes an associated luminous flux. An input is received, step 503, wherein the input identifies a desired luminous flux from the plurality of solid state light sources. Within the first set of data and the second set of data, the associated luminous flux that is the same as the desired luminous flux is located, step 504. The pair of x-axis coordinates and corresponding y-axis coordinates and corresponding correlated color temperature for the associated luminous flux are determined, step 505. Finally, the determined pair of x-axis coordinates and corresponding y-axis coordinates and corresponding correlated color temperature are used to adjust current to the plurality of solid state light sources to produce light output having a luminous flux that is substantially the associated luminous flux, step 506.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A lighting device, comprising:
a plurality of solid state light sources, comprising a first solid state light source having a first color point, a second solid state light source having a second color point, and a third solid state light source having a third color point;
a control circuit connected to the plurality of solid state light sources and configured to control an amount of current through each solid state light source in the plurality of solid state light sources to produce a light output for the lighting device; and
a memory system connected to the control circuit, wherein the memory system includes, for a range of correlated color temperatures:
a first set of data comprising a first plurality of pairs of x-axis coordinates and corresponding y-axis coordinates on the 1931 CIE Chromaticity Diagram, wherein each pair in the first plurality of pairs includes a corresponding luminous flux, wherein each corresponding luminous flux relates to a particular correlated color temperature over a first portion of the range; and
a second set of data comprising a second plurality of pairs of x-axis coordinates and corresponding y-axis coordinates on the 1931 CIE Chromaticity Diagram, wherein each pair in the second plurality of pairs includes a corresponding luminous flux, wherein each corresponding luminous flux relates to a particular correlated color temperature over a second portion of the range;
wherein the first plurality of pairs for the first portion of the range is determined by taking pairs of x-coordinates and corresponding y-coordinates from a black body curve for a first set of correlated color temperatures within the first portion of the range, and wherein the second plurality of pairs for a second set of correlated color temperatures within the second portion of the range is determined by taking pairs of x-coordinates and corresponding y-coordinates from a line that connects a first end point and a second end point, wherein the first end point is on the black body curve and the second end point is one of the first color point, the second color point, and the third color point.

2. The lighting device of claim 1, wherein the control circuit comprises an input circuit configured to receive an input, and wherein the control circuit is configured to, in response to the input being received, access the first set of data and the second set of data in the memory system to adjust the light output for the lighting device to a desired setting corresponding to the input.

3. The lighting device of claim 2, wherein the input defines one of a desired correlated color temperature and a desired luminous flux, for the light output.

4. The lighting device of claim 1, wherein a subset of pairs in the first plurality of pairs in the first set of data includes a dimming level corresponding to the luminous flux of the pair.

5. The lighting device of claim 4, wherein the control circuit comprises an input circuit configured to receive an input, wherein the input includes a desired dimming level, and wherein the control circuit is configured to, in response to the input being received, access the first set of data and the second set of data in the memory system to adjust the light output for the lighting device to the luminous flux corresponding to the desired dimming level.

6. The lighting device of claim 1, wherein the line that connects the first end point and the second end point is a line segment.

7. The lighting device of claim 1, wherein the line that connects the first end point and the second end point is defined by a plurality of line segments, wherein a first line segment in the plurality of line segments has a first slope, wherein a second line segment in the plurality of line segments has a second slope, and wherein the first slope is different from the second slope.

8. The lighting device of claim 1, wherein the line that connects the first end point and the second end point is a curve.

9. The lighting device of claim 1, wherein the line that connects the first end point and the second end point is a plurality of curves.

10. A method of dimming a plurality of solid state light sources, comprising:
creating a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures;
associating a luminous flux and corresponding dim level with each pair in the first plurality of pairs;
creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures;
associating a luminous flux and corresponding dim level with each pair in the second plurality of pairs;
receiving an input, wherein the input identifies a desired dim level;
locating, within the first set of data and the second set of data, the pair of x-axis coordinates and corresponding y-axis coordinates, corresponding correlated color temperature, and associated luminous flux for the corresponding dim level that is the same as the desired dim level; and
adjusting current to the plurality of solid state light sources to produce light output having a luminous flux that is substantially the luminous flux in the first set of data and the second set of data that is associated with the desired dim level.

11. The method of claim 10, wherein creating the second set of data comprises:
creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a line segment.

12. The method of claim 10, wherein creating the second set of data comprises:
creating a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a curve.

13. A lighting system comprising:
a plurality of solid state light sources, comprising a first solid state light source having a first color point, a second solid state light source having a second color point, and a third solid state light source having a third color point;
a controller connected to the plurality of solid state light sources; and
a memory system connected to the controller;
wherein the memory system includes a dimming application, a first set of data and a second set of data;
wherein the first set of data comprises a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and has an associated luminous flux;
wherein the second set of data comprises a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and has an associated luminous flux; and
wherein the dimming application, when executed in the controller as a dimming process, performs operations of:
receiving an input, wherein the input identifies a desired dim level;
locating, within the first set of data and the second set of data, the pair of x-axis coordinates and corresponding y-axis coordinates, corresponding correlated color temperature, and associated luminous flux for the corresponding dim level that is the same as the desired dim level; and
adjusting current to the plurality of solid state light sources to produce light output having a luminous flux that is substantially the luminous flux in the first set of data and the second set of data that is associated with the desired dim level.

14. A computer program product, stored on a non-transitory computer readable medium, including instructions that, when executed on a controller in communication with a plurality of solid state light sources, cause the controller to perform operations of:
storing a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and includes an associated luminous flux;
storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and includes an associated luminous flux;
receiving an input, wherein the input identifies a desired luminous flux from the plurality of solid state light sources;
locating, within the first set of data and the second set of data, the associated luminous flux that is the same as the desired luminous flux;
determining the pair of x-axis coordinates and corresponding y-axis coordinates and corresponding correlated color temperature for the associated luminous flux; and
using the determined pair of x-axis coordinates and corresponding y-axis coordinates and corresponding correlated color temperature to adjust current to the plurality of solid state light sources to produce light output having a luminous flux that is substantially the associated luminous flux.

15. The computer program product of claim 14, wherein the controller performs operations of storing a first set of data by:
storing a first set of data comprising a first plurality of pairs of x-axis coordinates and corresponding y-axis coordinates on the black body curve of the 1931 CIE Chromaticity Diagram for a first set of correlated color temperatures, wherein each pair in the first plurality of pairs corresponds to a correlated color temperature of the first set of correlated color temperatures and includes an associated luminous flux and corresponding dim level;
and wherein the controller performs operations of storing a second set of data by:
storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures and includes an associated luminous flux and corresponding dim level.

16. The computer program product of claim 15, wherein the controller performs operations of receiving by:
receiving an input, wherein the input identifies a desired dim level for light output by the plurality of solid state light sources;
wherein the controller performs operations of locating by:
locating, within the first set of data and the second set of data, the corresponding dim level that is the same as the desired dim level;
wherein the controller performs operations of determining by:
determining the pair of x-axis coordinates and corresponding y-axis coordinates and corresponding correlated color temperature for the corresponding dim level; and
wherein the controller performs operations of using by:
using the determined pair of x-axis coordinates and corresponding y-axis coordinates and corresponding correlated color temperature to adjust current to the plurality of solid state light sources to produce light output having a dim level that is substantially the corresponding dim level.

17. The computer program product of claim 15, wherein the controller performs operations of storing a second set of data by:
storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a line segment.

18. The computer program product of claim 15, wherein the controller performs operations of storing a second set of data by:
storing a second set of data comprising a second plurality of pairs of x-axis coordinates and corresponding y-axis coordinates on a line between a first end point and a second end point on the 1931 CIE Chromaticity Diagram for a second set of correlated color temperatures, wherein the first end point is on the black body curve and the second end point is a color point of a solid state light source in the plurality of solid state light sources, wherein each pair in the second plurality of pairs corresponds to a correlated color temperature of the second set of correlated color temperatures, and wherein the line is a curve.
